(19) United States
(12) Patent Application Publication
(10) Pub. No.: US 2009/0021605 A1
(43) Pub. Date: Jan. 22, 2009

(54) IMAGE CAPTURING DEVICE AND AUTO-FOCUS METHOD FOR SAME

(75) Inventor: MING-CHI PENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/875,163

(22) Filed: Oct. 19, 2007

(30) Foreign Application Priority Data
Jul. 20, 2007 (CN) 200710201145.8

(51) Int. Cl. H04N 5/76; H04N 5/232

(52) U.S. Cl. 348/231.99; 348/345; 348/E05.042

(57) ABSTRACT

An image capturing device includes a taking lens, an image sensor for capturing images of an object, an auto-focus system for focusing the image capturing device, and a memory. The memory stores an offset value represented between a pre-focus position and an in-focus position of the taking lens. The auto-focus system includes an image processing unit, a calculating unit, and a taking lens driving unit. The image processing unit is configured for comparing definition of the images to judge a clearest image therefrom, and detecting the pre-focus position of the taking lens. The calculating unit is configured for calculating the in-focus position of the taking lens according to the pre-focus position detected by the image processing unit and the offset value. The taking lens driving unit is used for moving the taking lens during focusing process.

### TECHNICAL FIELD

The present invention relates to an image capturing device and auto-focus method for same and, particularly, to an image capturing device and auto-focus method for raising auto-focus reliability.

### DESCRIPTION OF RELATED ART

With the development of optical imaging technology, image capturing devices are widely used in electronic devices, such as digital cameras and mobile phones. At present, most of the image capturing devices have auto-focus functions.

In an auto-focus process of a typical auto-focus image capturing device, a taking lens of the image capturing device is moved to many positions in order to detect an in-focus position. When the taking lens is at the in-focus position, the image capturing device can capture an image of an object clearly. But in many instances, because of the effect by the stability of the taking lens and other factors, the theoretical in-focus position detected by the image capturing device is not the actual in-focus position, but has an offset from the actual in-focus position. As a result, the image capturing device cannot focus accurately, thereby the image captured by the image capturing device may not satisfy the user.

What is needed, therefore, is an image capturing device which can solve the above problem and can focus accurately.

### SUMMARY

In accordance with one present embodiment, an image capturing device includes a taking lens, an image sensor for capturing images of an object at a variety of positions, an auto-focus system for focusing the image capturing device, and a memory. The memory stores an offset value, representing offset between a pre-focus position and an in-focus position, of the taking lens. The auto-focus system includes an image processing unit, a calculating unit, and a taking lens driving unit. The image processing unit is configured for comparing definition of the images to judge a clearest image thereof, and detecting the pre-focus position of the taking lens. The calculating unit is configured for calculating the in-focus position of the taking lens according to the pre-focus position detected by the image processing unit and the offset value. The taking lens driving unit is used for moving the taking lens during the focusing process. An auto-focus method is also presented.

### BRIEF DESCRIPTION OF THE DRAWING

Many aspects of the present image capturing device can be better understood with reference to the following drawings. The components in the drawing are not necessarily drawn to scale, the emphasis instead being placed upon clearly illustrating the principles of the present image capturing device. Moreover, in the drawings, like reference numerals designate corresponding parts throughout the several views.

FIG. 1 is a schematic, functional block diagram of an image capturing device according to a present embodiment;

FIG. 2 is a schematic, functional block diagram of an auto-focus system of the image capturing device of FIG. 1; and

FIG. 3 is a flow chart of an auto-focus method of an image capturing device.

### DETAILED DESCRIPTION OF THE EMBODIMENTS

Embodiments will now be described in detail below, with reference to the drawings.

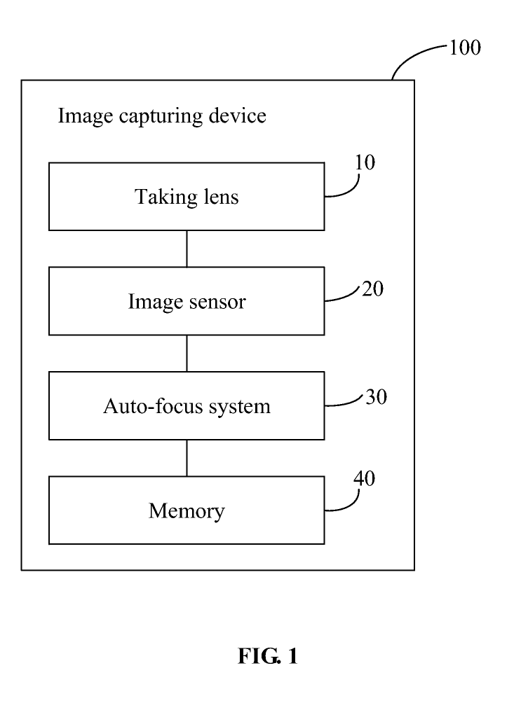

Referring to FIG. 1, an image capturing device 100, according to an embodiment, is shown. The image capturing device 100 includes a taking lens 10, an image sensor 20, an auto-focus system 30, and a memory 40. The image capturing device 100 can be a digital camera, a video camera, or a mobile phone with image capturing function.

The taking lens 10 can include many lenses capable of being divided into several lens groups. The taking lens 10 can be a zoom lens or a lens with fixed focal length.

The image sensor 20 is configured for converting light transmitted through the taking lens 10 to digital electrical signals. The image sensor 20 can be a charge-coupled device (CCD) or a complementary metal oxide semiconductor device (CMOS). The image sensor 20 can further be selected from a group consisting of a ceramic leaded chip carrier (CLCC) package type image sensor, a plastic leaded chip carrier (PLCC) package type image sensor, and a chip scale package (CSP) type image sensor.

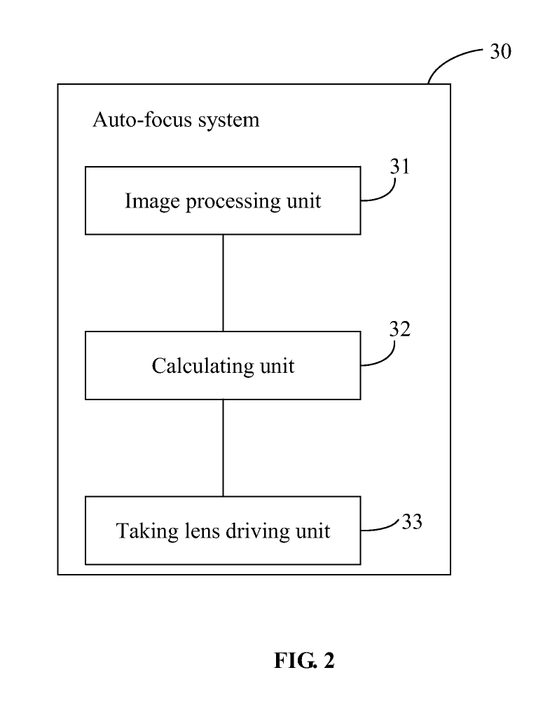

Referring to FIG. 2, the auto-focus system 30 is configured for focusing the image capturing device 100. The auto-focus system 30 can get an in-focus position of the taking lens 10 and driving the taking lens 10 to the in-focus position. The auto-focus system 30 includes an image processing unit 31, a calculating unit 32, and a taking lens driving unit 33.

The image processing unit 31 receives the electrical signals converted by the image sensor 20 and can get definition information of each image represented by the electrical signals. In a focusing process of the image capturing device 100, the taking lens 10 has to be moved to a number of positions and the image sensor 20 captures images at each of the positions. The image processing unit 31 compares the definition of these images in order to get a clearest image therefrom and gain the position of the clearest image. The definition information includes many kinds of data, such as for contrast, grayscale, and/or intensity. In order to shorten the focusing process of the image capturing device 100, the image processing unit 31 can compare the definition of the images using only one kind of definition information.

In many conventional image capturing devices, the position of the taking lens of the clearest image is considered to be the actual in-focus position of the taking lens. Here, we named the position ‘pre-focus position’. Because of the effect of the stability of the taking lens 10 and other factors, each image capturing device 100 has an offset value between the pre-focus position and the actual in-focus position. In the present embodiment, the offset value of the image capturing device 100 is stored in the memory 40. The offset value can be measured using any of many methods before the image capturing device 100 solids offered for sale. One method of measuring the offset value is moving the taking lens 10 to a number of positions and having the image sensor 20 capture images at each of the positions. Secondly, the definition of these images is compared to find a clearest image. The position of the clearest image can be considered as the in-focus position of the taking lens. So, the offset value can be calculated according to the in-focus position.

The calculating unit 32 is configured for calculating the in-focus position of the taking lens 10 according to the pre-focus position detected by the image processing unit 31 and the offset value stored in the memory 40.

The taking lens driving unit 33 is configured for moving the taking lens 10 during the focusing process. The taking lens driving unit 33 can move the taking lens 10 during the detecting process to find the pre-focus position before getting the in-focus position, and move the taking lens 10 to the in-focus position after the calculating unit 32 calculates the in-focus position of the taking lens 10.

Preferably, the memory 40 is a Read Only Memory (ROM) to prevent the offset value stored in the memory 40 from being inadvertently changed or lost.

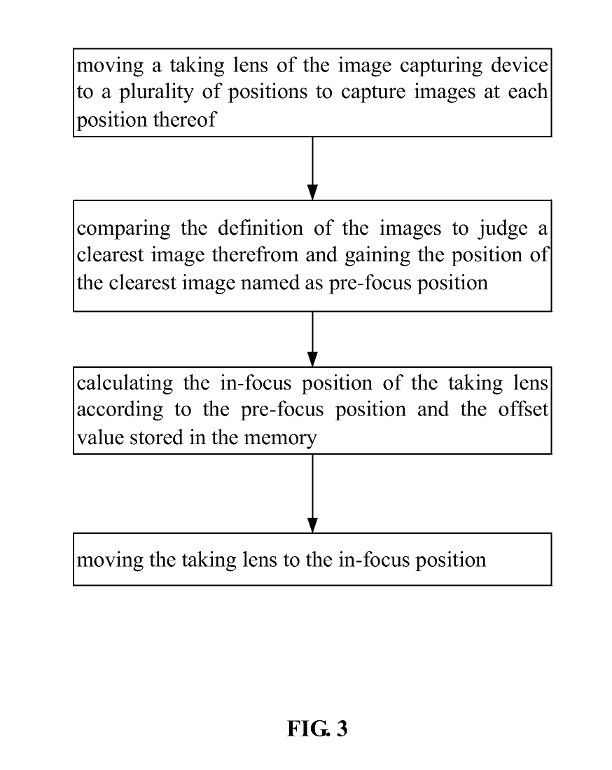

Referring to FIG. 3, an auto-focus method of the image capturing device 100 is also provided. The method includes the steps of: moving the taking lens 10 to a number of positions to get images at each position thereof; comparing the definition of the images to judge a clearest image therefrom and gaining the position of the clearest image named as pre-focus position; calculating the in-focus position of the taking lens 10 according to the pre-focus position and the offset value stored in the memory 40; moving the taking lens 10 to the in-focus position.

In the process of comparing the definition of the images to judge a clearest image therefrom, it is advantageous to limit the definition information used in or to keep the auto-focusing time to a minimum.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An image capturing device comprising:
a taking lens;
an image sensor for capturing images at a variety of positions;
a memory for storing an offset value represented between a pre-focus position and an in-focus position of the taking lens, and
an auto-focus system for focusing the image capturing device, the auto-focus system comprising:
an image processing unit for comparing definition of the images to judge a clearest image therefrom, and detecting the pre-focus position of the taking lens corresponding to the clearest image;
a calculating unit for calculating the in-focus position of the taking lens according to the pre-focus position detected by the image processing unit and the offset value; and
a taking lens driving unit for moving the taking lens during focusing process.

2. The image capturing device as claimed in claim 1, being selected from a group consisting of a digital camera, a video camera, and a mobile phone.

3. The image capturing device as claimed in claim 1, wherein the image sensor is one of a charge-coupled device and a complementary metal oxide semiconductor device.

4. The image capturing device as claimed in claim 1, wherein the image sensor is selected from a group consisting of a ceramic leaded chip carrier package type image sensor, a plastic leaded chip carrier package type image sensor, and a chip scale package type image sensor.

5. The image capturing device as claimed in claim 1, wherein the image processing unit compares the definition of the images according to the definition information of the images, the definition information is selected from a group consisting of contrast information, grayscale information, and intensity information.

6. The image capturing device as claimed in claim 1, wherein the image processing unit compares the definition of the images using one kind of definition information of the images.

7. The image capturing device as claimed in claim 1, wherein the offset value is stored in the memory before the image capturing device being sold.

8. The image capturing device as claimed in claim 1, wherein the offset value is measured by the steps of: moving the taking lens at a plurality of positions to capture images of each position; comparing the definition of these images to judge a clearest image therefrom using a plurality of kinds of definition information of the images and gaining the position of the clearest image; using the position of the clearest image as the in-focus position of the taking lens to calculate the offset value.

9. The image capturing device as claimed in claim 1, wherein the memory is a Read Only Memory.

10. An auto-focus method of an image capturing device, the image capturing device comprising a memory storing an offset value represented between a pre-focus position and an in-focus position of a taking lens of the image capturing device, the method comprising the steps of:
moving the taking lens of the image capturing device to a plurality of positions to capture images at each position thereof;
comparing the definition of the images to judge a clearest image therefrom and gaining the position of the clearest image named as pre-focus position;
calculating the in-focus position of the taking lens according to the pre-focus position and the offset value stored in the memory; and
moving the taking lens to the in-focus position.

11. The method as claimed in claim 10, wherein comparing the definition of the images uses definition information of the images, the definition information is selected from a group consisting of contrast information, grayscale information, and intensity information.

12. The method as claimed in claim 10, wherein comparing the definition of the images uses one kind of definition information of the images.

13. The method as claimed in claim 10, wherein the offset value is measured by the steps of: moving the taking lens to a plurality of positions to capture images at the positions; comparing the definition of these images to judge a clearest image therefrom using many kinds of definition information of the images and gaining the position of the clearest image; using the position of the clearest image as the in-focus position of the taking lens to calculate the offset value.
